(19) United States
(12) Patent Application Publication
(10) Pub. No.: US 2016/0292275 A1
(43) Pub. Date: Oct. 6, 2016

(54) SYSTEM AND METHOD FOR EXTRACTING AND SEARCHING FOR DESIGN

(71) Applicant: Apropose, Inc., Redwood City, CA (US)

(72) Inventors: Jerry O. Talton, Redwood City, CA (US); Ranjitha Kumar, Redwood City, CA (US); Maxine Lim, Redwood City, CA (US); Dan Fike, Redwood City, CA (US); Yi-Ting Yeh, Redwood City, CA (US); Ningxia Zhang, Redwood City, CA (US)

(21) Appl. No.: 15/089,329

(22) Filed: Apr. 1, 2016

Related U.S. Application Data
(60) Provisional application No. 62/142,933, filed on Apr. 3, 2015.

(51) Int. Cl. G06F 17/30; H04L 29/08; G06T 11/00; G06F 17/22

(52) U.S. Cl. CPC G06F 17/30864; G06F 17/30477; G06F 17/2247; H04L 67/02; G06T 11/001

(57) ABSTRACT

A system and method for extracting and searching for design includes identifying design examples using a query system hosted on a server having one or more processors and memory. The system and method include receiving a first query, searching a design repository based on the first query to determine a result set having one or more first design examples, returning the first design examples, determining one or more first similarities among design properties in second design examples selected from the first design examples, and using the first similarities as a basis for one or more second queries. The design repository stores domain object model (DOM) trees, DOM elements, design properties, and snapshots. In some embodiments, the system and method further include adding one or more of the first design examples to a trendset and determining one or more second similarities of design properties in third design examples in the trendset.

### RELATED APPLICATIONS

This application claims priority to U.S. Provisional Patent Application Ser. No. 62/142,933, filed on Apr. 3, 2015, which is incorporated by reference herein.

### TECHNICAL FIELD

The present disclosure relates generally to computing systems and the use of design, and more particularly to extracting and searching for design.

### BACKGROUND

During the design of web pages, documents, and other visual media, there are common design practices that are implemented across numerous web pages, websites, documents, and/or the like. Web and document designers commonly try to create a visual and interaction experience that both follows common design patterns but also achieves a branded, unique and appropriate style. Following design patterns, however, is a difficult process. Designers and developers have the burden of locating reputable sources of design knowledge, assimilating that knowledge, and applying that knowledge to their own project. Further complicating the design process is that the appropriate design patterns are highly variable—changing over time, particular style, and application. As designers search for suitable design patterns and templates they are typically confronted with an ever growing and ever changing array of examples with very few useful tools for extracting the salient and/or relevant design elements and properties from the examples. In addition, the designers are generally not able to search for and examine large numbers of examples with common and/or similar properties.

Accordingly, there is a need in the design field to create new and useful systems and methods for extracting the properties of existing designs and supporting useful and helpful comparisons and searches from among the extracted properties.

### SUMMARY

According to some embodiments a method of identifying design examples using a query system hosted on a server having one or more processors and memory includes receiving a first query, searching a design repository based on the first query to determine a result set having one or more first design examples, returning the first design examples, determining one or more first similarities among design properties in second design examples selected from the first design examples, and using the first similarities as a basis for one or more second queries. The design repository stores domain object model (DOM) trees, DOM elements, design properties, and snapshots.

According to some embodiments, a method of extracting design properties associated with a web page using a collection system hosted on a server having one or more processors and memory includes retrieving the web page using a web crawler, retrieving one or more resources associated with the web page using the web crawler, rendering the web page using a web browser instance, extracting a domain object model (DOM) tree having one or more DOM elements for the web page, saving the DOM elements and the DOM tree in a design repository, extracting one or more design properties for each of the DOM elements from the web page and the resources, saving the design properties in the design repository, extracting a first screen shot for at least one of the DOM elements from the rendered web page, and saving the first screen shot in the design repository.

According to some embodiments, a system includes a first server. The first server includes a first memory and one or more first processors coupled to the first memory. The first server is configured to implement a query system. The query system is configured to receive a first query, search a design repository to determine a result set having one or more first design examples based on the first query, return the first design examples, determine one or more first similarities among second design properties in second design examples selected from the first design examples, and use the first similarities as a basis for one or more second queries. The design repository storing first document object model (DOM) trees, first DOM elements, first design properties, and first snapshots.

### BRIEF DESCRIPTION OF THE DRAWINGS

FIG. 1 is a simplified diagram of a design support system according to some embodiments.

FIG. 2 is a simplified diagram of a collection and query system for design according to some embodiments.

FIG. 3 is a simplified diagram of a method of design property extraction according to some examples.

FIG. 4 is a simplified diagram of a method of querying a design repository according to some embodiments.

In the figures, elements having the same designations have the same or similar functions.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Without loss of generality, the systems and methods in the embodiments of the present disclosure may preferably be applied to any design field where design is represented in a structured design document or documents. Although the systems and methods are presented in the context of website design, they may similarly be applied to other fields of interface and visual design such as native application design, graphical design, document design, presentation design, media design, and other suitable forms of design in the digital field. In some examples, when the systems and methods are applied to web design, the website resources may include resources such as web markup documents (HTML, XHTML, and the like), cascading style sheets (CSS), JavaScript, images, video, and/or the like. In some examples, when the systems and methods are applied to document design, the document layout may be encoded in an AI, PDF, SVG, EPS files, and/or the like. In some examples, when the systems and methods are applied to application design, the design may be defined through different source code files, template files, and/or the like. In some examples, when the systems and methods are applied to presentation design, the presentation design may be contained in the PowerPoint file or other presentation file. More broadly, the systems and methods may be applied to 3D model design (as in architecture and industrial design), fashion design (clothing pattern design, print pattern design, jewelry design, and the like) and other fields of design. Herein, the systems and methods are described in the context of web design, but as one knowledgeable in the art will recognize, the systems and methods may be applied to other suitable design fields.

According to some embodiments, design patterns are often represented as suggestions for one or more design elements and/or in the form of representative examples. In some examples, a design element is sometimes expressed by a set of properties that are translated into some representation in a document or product. In some examples, design elements may include a header, footer, sidebar, background, menu, menu item, article, comments section, an individual comment, a form, an individual form field, a button, a user interface element like a dropdown or checkbox, or any suitable element. As can be appreciated in these examples, design elements may have various design property relationships such as parent-child hierarchical relationships or class relationships. In some examples, design elements may include shared and/or unique design properties with other design elements in the same web page or in different web pages.

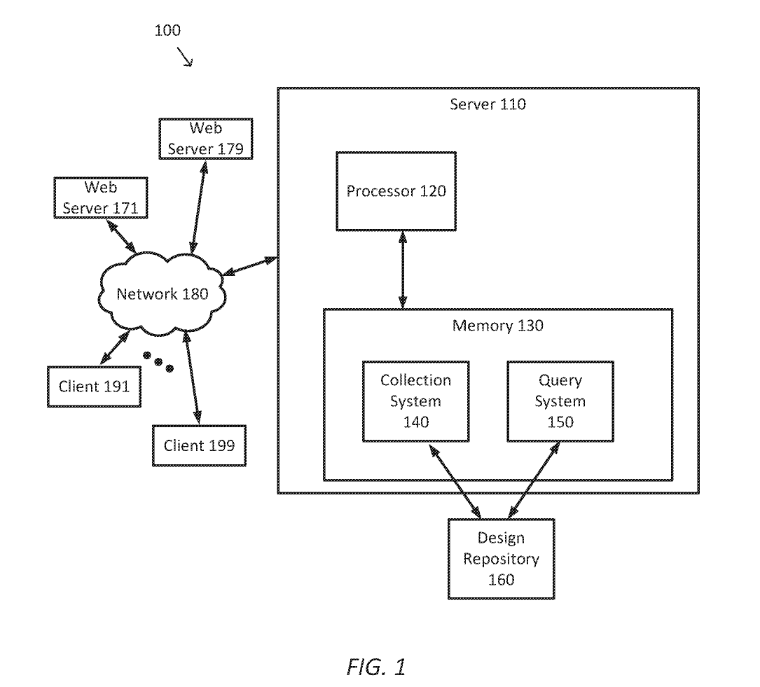

FIG. 1 is a simplified diagram of a design support system 100 according to some embodiments. As shown in FIG. 1, design support system 100 is built around a client-service model. Design support system 100 includes a server 110 that provides much of the functionality that supports design extraction and search. In some examples, server 110 may be a standalone workstation, a cluster, a production server, within a virtual machine, and/or the like. Server 110 includes a processor 120 coupled to memory 130. In some examples, processor 120 may control operation and/or execution of hardware and/or software on server 110. Although only one processor 120 is shown, server 110 may include multiple processors, multi-core processors, field programmable gate arrays (FPGAs), application specific integrated circuits (ASICs), and/or the like. Memory 130 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Memory 130 may be used to store one or more applications, services, software systems, and/or the like that help enable the functionality provided by server 110. Each of the applications, services, software systems, and/or the like may include one or more interfaces for managing and/or accessing the functionality of the applications, services, software systems, and/or the like as is discussed in further detail below. Two of the software systems include a collection system 140 and a query system 150. In some examples, collection system 140 is used to locate and examine existing examples of design, which are then loaded, analyzed, cataloged, categorized, and so forth before being stored in a design repository 160 as design information. Query system 150 may then be used to access the design information in design repository 160 to support a designer in the development and/or modification of existing designs.

In some examples, the design information of design repository 160 may be stored as one or more files and/or more database tables in persistent storage. In some examples, the files and/or database tables may be stored as one or more relational databases, nosql databases, flat files, eXtensible Markup Language (XML) files, Simple Object Access Protocol (SOAP) files, and/or the like. In some examples, design repository 160 may be accessed using any suitable data source driver such as an open database connectivity (ODBC) driver, a java database connectivity (JDBC) driver, and/or the like. In some examples, the persistent storage may include one or more disk drives, disk arrays, RAID arrays, FLASH arrays, distributed storage, and/or the like. In some examples, the persistent storage may be located local to server 110 and/or remotely to server 110.

In the web-based embodiments of FIG. 1, examples of existing designs are hosted on various web servers 171-179 as one or more web pages or websites. Access to the websites and web servers 171-179 is typically obtained over a network 180, such as the internet, although one or more of the web servers 171-179 may be accessed via local area networks (LANs), private networks, and/or the like, which may be considered part of network 180. To access the designs in the web pages and/or websites of web servers 171-179, collection system 140 surfs to and/or crawls over the web pages and websites to extract the design properties of the web pages and/or websites for inclusion as the design information in design repository 160.

Once the design information is recorded in design repository 160, one or more clients 191-199 may access the design information in design repository 160 using query system 150. Each of the clients 191-199 may issues queries and/or requests to query system 150 over network 180. Query system 150 then processes the queries and/or requests to find examples of designs consistent with the queries and/or requests and returns them to the respective requesting client 191-199 for presentation to a designer and/or other user.

As discussed above and further emphasized here, FIG. 1 is merely an example which should not unduly limit the scope of the claims. One of ordinary skill in the art would recognize many variations, alternatives, and modifications. In some embodiments, different topological arrangements for server 110, web servers 171-179, and/or clients 191-199 are possible. In some examples, server 110 may host one or more of the web servers 171-179. In some examples, server 110 may host one or more of the clients 191-199, such as in the form of a locally running design tool or application. In some examples, either or both of collection system 140 and query system 150 may be operated in distributed fashion over multiple servers either as distributed applications/system or as parallel instances allowing separate collection and/or query using multiple servers consistent with server 110. In some examples, collection system 140 and query system 150 may be hosted in separate servers so that collection system 140 may be hosted by one or more servers that are distinct from one or more servers hosting query system 150.

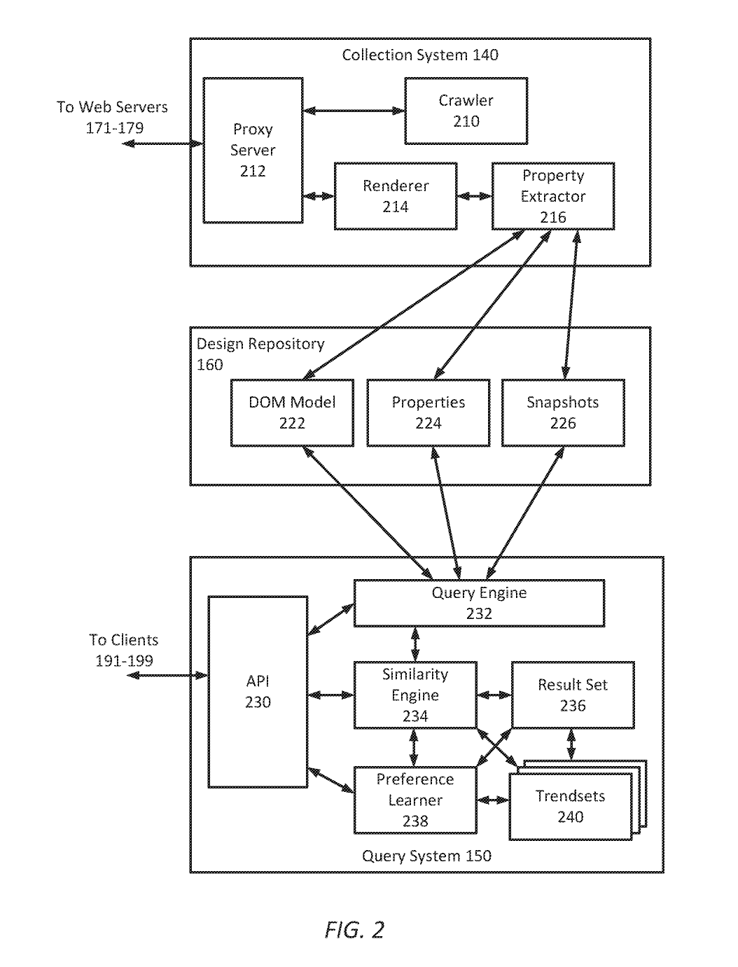

FIG. 2 is a simplified diagram of a collection and query system for design according to some embodiments. As shown in FIG. 2, further detail regarding several possible embodiments for collection system 140, query system 150, and design repository 160 is presented.

In the embodiments of FIG. 2, collection system 140 is organized using a web crawler model based around a web crawler 210. Web crawler 210 is initially provided with a seeding set of web pages or websites in the form of one or more uniform resource locators (URLs). Web crawler 210 then builds a queue using the URLs and then uses one or more parallel processes to request the web pages at each of the URLs in turn through a proxy server 212. Proxy server 212 retrieves the web pages at the requested URL from one of the web servers 171-179. As each of the requested web pages is returned to web crawler 210 through proxy server 212, the resulting HTML is parsed to identify any links within the HTML, which are then added to the queue of URLs for each of the URLs associated with the links that has not been previously crawled.

In addition to fetching the web pages requested by web crawler 210, proxy server 212 also monitors and tracks each resource request used to retrieve each requested web page. This includes resources such as embedded content, images, cascading style sheets (CSSs), and/or the like. In some examples, the requested web page and each of the resources are then tagged with an identifier associated with the web page so that subsequent processing of the web page for design properties may know which resources are associated with which web pages. Once the web page and its resources have been retrieved they are passed to a renderer 214. In some examples, renderer 214 includes a web browser instance, such as a Webkit browser, that is capable of using the web page and the resources to render the web page as it would be displayed on a mobile device, tablet, and/or computer screen.

The retrieved web page, its resources, and the rendered image of the web page are then provided to a property extractor 216. Property extractor 216 is responsible for extracting the design properties and other design information used on the web page for storage in desugb repository 160. Property extractor 216 parses the raw HTML and/or other resources used to generate the web page to extract a Document Object Model (DOM) tree representation of the various elements and features included in the hierarchy that forms the web page. This includes the root or container DOM element that represents the web page as a whole and each of the child DOM elements that are part of the root DOM element. This extraction continues recursively until each DOM element that is a part of the web page has been extracted and added to the DOM tree. Property extractor 216 then records the DOM tree in a DOM model 222 located in design repository 160. In some examples, DOM model 222 may include one or more database tables, such as a table with a row or entry for each node in the DOM tree with appropriate associations to a parent DOM element, one or more child DOM elements, a web page table, and design properties for the DOM element as discussed further below. In some examples, the recursion continues until each DOM element is identified and extracted including DOM elements that may include content as small as a few characters and/or a small image.

In some embodiments, a bounding box for each DOM element that describes a screen space position of the DOM element is determined and then used to limit the extraction of design properties to DOM elements that contribute to the visual rendering of the web page. In some examples, once the bounding box for each DOM element is determined, it may be recorded as part of DOM model 222 as an absolute and/or fractional position relative to a reference point on the web page. In some examples, additional information regarding the bounding box may be recorded including height, width, area, aspect ratio, and/or the like. In some examples, the bounding box of each DOM element is examined to determine whether it is too small and/or off screen so that it does not contribute in a meaningful way to the design of the web page. In some examples, the bounding box of each DOM element is then compared to the bounding boxes of neighboring DOM elements in the DOM tree to determine whether the DOM element is overlapped entirely by one or more of the neighboring DOM elements and does not contribute to the design of the web page. In some examples, when a DOM element does not contribute meaningfully to the design of the web page it may be removed and/or pruned from the DOM tree and is not recorded in DOM model 222. In some examples, this pruning of DOM elements may provide a cleaner structural representation of the web page and/or support a truer characterization of the design present in the web page. In some examples, the pruning may also result in improved efficiency in other computational tasks. In some examples, the DOM elements may be added to DOM model 222 using one or more insert statements.

In some embodiments, once the DOM tree is determined, design properties for each of the DOM elements are extracted by property extractor 216 for storage in design repository 160 as properties 224. In some examples, properties 224 may include one or more database tables, such as a table with a row or entry for each design property discovered as well as appropriate associations to a DOM element having the property, a web page using the property, and/or the like. In some examples, a row or entry may be used for each instance of the design property and/or one or more associative tables may be used to model the many to many relationships between design properties and DOM elements and/or web pages. In some examples, the design properties elements may be added to properties 224 using one or more insert statements.

In some embodiments, design properties may be determined by correlating information found in the raw HTML for the web page, the web page source, the DOM tree, the other resources for the web page (such as CSS information), and/or one or more screenshots available through renderer 214. In some examples, use of information from each of these sources may provide for more structural and/or semantic context for the design properties being extracted. In some examples, the design properties extracted and stored in properties 224 may include information associated with colors, fonts, sizes, and/or any of the hundreds of properties that may be expressed for DOM elements in web pages. In some examples, the design properties for a DOM element may be inherited from other DOM elements, assigned via a CSS, explicitly set in the page source, and/or are present in an embedded image. In some examples, the design properties may be based on general design classifications for the web pages and their content. In some examples, the classifications may include determinations of whether the web pages are monotone, colorful, bright, dark, light, blue-palette, tri-tone palette, and/or the like based on one or more parametric models and/or heuristic rules for making a classification determination.

In some embodiments, property extractor 216 may further store one or more rendered images of the web page in design repository 160 in a collection of snapshots 226. In some examples, snapshots 226 may include one or more database tables, such as a table with a row or entry for each snapshot stored as a binary large object (BLOB) or similar as well as appropriate associations to a DOM element represented by the snapshot, a design property embodied in the snapshot, a web page from which the snapshot is obtained, and/or the like. In some examples, the screen shots may be added to snapshots 226 using one or more insert statements.

In some embodiments, rather than recording a list of fonts that are mentioned in the raw HTML source for a web page, the web page source, the CSS, the DOM tree, and/or the like may be used to determine which fonts are actually used to render text on the web page. Thus, where text is rendered on the web page, the size, color, slant, boldness, and/or other semantic information associated with the font by the web page source, such as CSS class or id, may be detected and extracted. In some examples, each use of a font in a DOM element may be determined along with a screen-space region where it appears on the rendered web page, such as via the bounding box for the DOM element. In some examples, the screen-space region may be used to generate a screenshot of the font in use and the screenshot may further be recorded in snapshots 226 for later use when a representative example of the font in use is desired. In some examples, the sources of font information may also be used to categorize usage of the fonts according to their semantic and structural “role” on the web page. In some examples, the categorization may include “header”, “body”, “title”, and/or the like.

In some embodiments, a color palette associated with the web page may be determined using a screenshot of the entire web page obtained from the renderer 214. In some examples, the color palette may be stored in the properties 224. In some examples, the screenshot may be examined pixel by pixel to compute a quantized color histogram over the screenshot. In some examples, the quantizing may be based on a fixed bucket size, a bucket size based on a dynamic range of the colors on the web page, using a clustering algorithm, such a k-means, and/or the like. In some examples, the buckets may be determined based on the colors specified in the CSS and visible according to the DOM tree so that colors in the screenshot may be corrected for quantization error in the screenshot. In some examples, correlations between where the colors are used and the bounding boxes of the DOM elements may be used to determine semantic properties of the colors. In some examples, relative frequency of the colors in the histogram may be used to label each of the colors as “coverage,” “accent,” or “detail.” In some examples, this additional semantic information and/or labeling may be used to correlate important visual information that is not present in the page source or DOM tree with page elements. In some examples, these correlations may be used to detect that the predominant color in an image-based navigation bar is red and label it accordingly, even though the only visual information discernible from the DOM tree and the web page source might be the name of the image. In some examples, additional image processing techniques may be used to detect important design properties of the web page and/or one or more of the DOM elements, such as the use of a background image that includes a large face, an animated image, and/or other commonly used design element.

In some embodiments, property extractor 216 may further extract one or more additional properties of a web page and/or a website for storage in design repository 160. In some examples, the one or more properties may be identified by parsing the web page and/or website for the presence of text patterns, use of in-memory data variables when the web page and/or website is loaded using renderer 214, and/or the like.

In some examples, the one or more properties may include use of one or more design frameworks and optionally version numbers, such as Squarespace, Wordpress, Wix, Drupal, and/or the like to build the web page and/or the website. In some examples, the one or more properties may include use of one or more web technologies and/or libraries and optionally version numbers, such as HTML5, Flash, AngularJS, ReactJS, Foundation, jQuery 1.9, jQuery 1.12.1, and/or the like to build the web page and/or the website and/or found in the raw HTML for the web page and/or website. In some examples, the one or more properties may include one or more dates associated with the web page and/or website, such as copyright years found on the web page and/or website, indicators or last modified date, and/or the like. In some examples, the one or more properties may include an overall evaluation of the legibility of the web page and/or website, such as indicated by font sizes, visibility of details in images, and/or the like. In some examples, the one or more properties may include general modernity of the web page and/or website based on the use and/or presence of various design frameworks, web technologies, libraries, and/or the like and/or version numbers of the frameworks, web technologies, libraries, and/or the like. In some examples, the one or more properties may include use of cascading style sheet (CSS) animations, and/or the like. In some examples, the one or more properties may include how responsive the web page and/or website is when loaded by renderer 214 to test the web page and/or website on various devices including mobile devices, tablets, and/or computer screens. In some examples, the one or more properties may include semantic concepts included in the content of the web page and/or website that indicate that the web page and/or website is associated with a particular business, such as a hotel, a restaurant, a salon, a specialty shop, and/or the like.

In some embodiments, property extractor 216 may further extract contact information associated with the web page and/or the website for storage in design repository. In some examples, the contact information may be identified by parsing the web page and/or website for the presence of text patterns indicative of contact information, such as keywords, common patterns, and/or the like. In some examples, the keywords may include such words as “contact”, “locations”, “telephone”, “tel”, “address”, and/or the like. In some examples, the common patterns may include various phone number patterns, email patterns, postal code patterns, and/or the like. In some examples, the phone number patterns may include 7 digit (e.g., XXX-XXXX) or 10 digit (e.g., (XXX) XXX-XXXX, YYY.YYY.YYYY) patterns, international dialing patterns (e.g., +ZZ), and/or the like. In some examples, the email patterns may include patterns with an @ symbol followed by a domain, an indication of whether the domain is consistent with the domain used in the URL for the web page and/or website, and/or the like. In some examples, a context of the contact information, such as its presence in commonly used tags, such as <footer>, location on pages that identify contact and/or location information, distance from a top-level and/or main landing page for the website, and/or the like. In some examples, the context of the contact information may optionally be used to infer whether the contact information is associated with a preferred point of contact for the web page and/or website.

In some embodiments, collection system 140 and web crawler 210 may be periodically retriggered to capture trend information associated with the crawled web pages and websites. In some examples, when periodic crawling of a web page or website is desired, each of the DOM elements recorded in DOM model 222, the design properties recorded in properties 224, and the screen shots recorded in snapshots 226 may also be recorded with a timestamp. In some examples, the time stamps may be used to support comparisons between different instances of a web page as it evolves over time.

Referring now to query system 150, in the embodiments of FIG. 2, query system 150 is organized around a client-services model providing an externally facing application programming interface (API) 230. API 230 provides an interface via which clients, such as clients 191-199, may access query system 150 to take advantage of the design information stored in design repository 160. In some examples, API 230 may provide one or more mechanisms by which a user or client may make queries to search the design repository 160 to find examples of web pages and/or DOM elements that satisfy one or more design criteria. In some examples, API 230 may include a software library API for use by a local design application via linking and function calls. In some examples, API 230 may include a network-based interface that may support a representational state transfer (REST) interface, a SOAP web service, and/or other web service interface. In some examples, the network-based interface may support use of query system 150 by one or more web applications that may provide design search tools using one or more web pages that may be accessed through a web browser.

API 230 is supported by a query engine 232 that is used to formulate queries that access the design information stored in design repository 160. In some examples, when design repository 160 is implemented using a database, query engine 232 may provide one or more functions that generate structured query language (SQL) and/or other query language queries to access the tables of DOM model 222, properties 224, and snapshots 226. In some examples, the queries supported by query engine may be based on any of the design properties (such as color, font, and/or the like) and/or other semantic information (such as genre, layout, visual style, trend, and/or the like) stored in properties 224 and/or any combination of design properties and semantic information. As but some of the many possible examples, query engine 232 may provide support for queries that may answer one or more of the following questions: “find pages with a coverage color of red”, “find pages with a coverage color of red and an accent color of pink”, “find pages using Helvetica font”, “find examples of the Helvetica font in red with a typeface of at least 24 points”, “find restaurant pages with a big face background”, “find restaurant pages that use the Neutra Text typeface and have a large video background”, “find pages whose coverage color changed from red to blue”, and/or the like.

In some embodiments, query engine 232 may support the generalization, similarity, and/or imprecision when forming queries for the design repository. In some examples, specification of a color may be treated as a range of colors. In some examples, named colors such as red, blue, green, etc. may describe a range of colors with a predefined and/or customizable range of values in an RGB, HSV, and/or similar color space. In some examples, colors specified in the RGB, HSV, and/or similar color space may be queried for as a range and/or volume of colors about the specified color value. In some examples, fonts may be classified by font family, font type (such a serif, san serif, presentation, and/or the like) in order to support queries looking for fonts with a similar look and/or design quality.

In some embodiments, a result set 236 from a query made by query engine 232 is returned to the requesting client and/or the user via API 230. In some examples, result set 236 may be implemented using any suitable collection data structure, such as a set, an array, a vector, and/or the like. In some examples, API 230 may return the result set 236 as a collection of web pages that match the query for display to the user and/or at the client. In some examples, the result set 236 may demonstrate the relevant design properties specified in the query. In some examples, when the query is associated with a request for web pages having the indicated design properties, the result set 236 may include a collection of screen shots stored in snapshots 226 that correspond to the result set 236. In some examples, the result set 236 may correspond to the screen shots of the web pages corresponding to the result set 236. In some examples, the result set 236 may correspond to screen shots focused on the specified design properties so that the result set 236 includes screen shots of the DOM element that uses the specified design properties. In some examples, when the query answers the question “find examples of the Helvetica font in red with a typeface of at least 24 points”, examples of DOM elements with red Helvetica characters of 24 points or larger are returned in result set 236. In some examples, when the result set 236 is from a query involving color, the result set 236 may be returned as a color palette including the most common colors used by the respective web page and/or DOM element. In some examples, when the size of the result set 236 is larger than a configurable threshold, such as 20, the result set 236 may be returned in groups of the size of the threshold. In some examples, the result set 236 may be ordered based on how closely the result set 236 matches the design properties in the query. In some examples, the ordering may be based on closeness of color, closeness of font size, strength of classification of the web page or the design property, and/or the like and/or any combination of factors.

Query system 150 further includes a similarity engine 234. Similarity engine 234 uses one or more web pages selected by a user as design examples on which query engine 232 may base queries and searches of design repository 160. In some examples, the one or more selected web pages and/or all the web pages may be selected from result set 236. In some examples, similarities in design properties may be determined based on exact matches between design properties (e.g., all selected examples use the Roboto font, all examples include a specific shade of red, etc.). In some examples, similarities in properties may be determined based on approximate matches in design properties (e.g., all selected examples use a shade of red, all examples use a san serif font, etc.) In some examples, one or more similarity measures and/or relations (e.g., two colors are similar when they are within a predetermined distance of each other in an RGB, HSV, and/or other color space) may be used to determine approximate matches. In some examples, similarity engine 234 may additionally determine one or more lists of design properties in each of the selected examples. In some examples, the one or more lists may be ordered based on how often each of the design properties is in the selected examples. In some examples, the ordering may be used to determine the popularity of the design properties in the selected examples. In some examples, popularity may be determined based on a configurable threshold of a percentage of selected examples that use the design property, a configurable number and/or percentage of the design properties that are used in the most selected examples, and/or the like. In some examples, similarity engine 234 may also return an explanation and/or description of the observed similarities in the selected examples. In some examples, the explanation may include observations, such as “the selected examples include bright colors and serif fonts.” In some examples, similarity engine 234 may include one or more heuristic rules and/or the like for making recommendations to the client and/or user, such as “you might be interested in designs with large video backgrounds, because they also often use bright colors and serif fonts.”

In some embodiments, a user of query system 150 may also identify and/or manage collections of examples web pages using one or more trendsets 240. In some examples, each of the trendsets 240 may be implemented using any suitable collection data structure, such as a set, an array, a vector, and/or the like. In some examples, as the user reviews the result set 236 and/or selects examples for the result set 236, the user may save and/or add the result set 236 and/or the selected examples from the result set 236 to one or more of the trendsets 240. In some examples, the user may additionally manage the one or more trendsets 240 by loading one of the trendsets 240, merging trendsets 240, deleting examples from one or more of the trendsets 240, and/or the like. In some examples, when the user creates one of the trendsets 240, adds one or more examples to one of the trendsets 240, and/or removes examples from one of the trendsets 240, similarity engine 234 analyzes the design properties in the new and/or altered one of the trendsets 240 to determine one or more design properties each of the examples in the one of the trendsets 240 has in common. In some examples, similarity engine 234 may determine similar design properties, create and/or order lists of design properties, and/or the like for each of the trendsets 240 in similar fashion to the way similarity engine 234 analyzes result set 236 and/or selected examples from result set 236. In some examples, machine learning may be used to recommend additional web pages and/or examples for inclusion in one or more of the trendsets 240. And although the trendsets 240 are depicted in FIG. 2 as being part of query system 150, the trendsets 240 may be stored separately from query system 150, such as in design repository 160 and/or in any other repository and/or persistent storage system for recovery, use, and/or management at a later time.

In some embodiments, use of similarity engine 234, result set 236, and/or the trendsets 240 may provide additional options for enhancing the capabilities of query engine 232. In some examples, the similar design properties across the examples in result set 236 and/or the trendsets 240 and/or the lists of design properties from result set 236 and/or the trendsets 240 may also be used as the basis for additional query options, parameters, and/or capabilities based on any of the axes of similarity in result set 236 and/or the trendsets 240. In some examples, the similar design properties and design property lists may support queries where some similar design properties are included and others are rejected, such as to support a query about likes and dislikes in result set 236 and/or the trendsets 240. As but some of the many possible examples, query engine 232 as supported by similarity engine 234 may provide support for queries that may answer one or more of the following questions: “find pages with similar fonts as the selected examples from the result set”, “find pages with similar fonts and colors as the result set”, “find pages with similar design properties as trendset 1”, “find pages with the same fonts as the result set, but with different colors than trendset 1”, “find pages with bright restaurant pages that use different fonts than the result set”, “find pages with bright restaurant pages with nearby search engine optimization (SEO) rankings”, “find pages with the most frequently used fonts in the result set”, “find pages with the most frequently used rare fonts in trendset 1”, “find pages with colors similar to trend set 1, fonts similar to trend set 2, and different fonts from trend set 3”, etc.)

Query system 150 further includes a preference learner 238. In some examples, as clients and/or users use query system 150, preference learner 238 may use correlations between result set 236, subsequent queries submitted through query engine 232, and/or additions and/or deletions to one or more of the trendsets 240 may be used to determine preferences and/or associations between web pages and/or examples with different design properties. As but one of many possible examples, preference learner 238 may be used to make observations such as users who searched for dark pages and then technology sites tend to click on minimal designs.” In some examples, the preferences and/or associations learned may be used to determine new design classification, provide better recommendations, develop better statistical models of design preferences, and/or the like. In some examples, the preferences may be applied to individual clients and/or user and/or to each client and/or user of query system 150.

As discussed above and further emphasized here, FIG. 2 is merely an example which should not unduly limit the scope of the claims. One of ordinary skill in the art would recognize many variations, alternatives, and modifications. In some embodiments, proxy server 212 is optional and may be omitted. In some examples, web crawler 210 requests the web pages from the web servers 171-179 and receives them from the web servers 171-179 without first passing them through proxy server 212. In some examples, web crawler 210 monitors and tracks the resource requests used to retrieve the web pages.

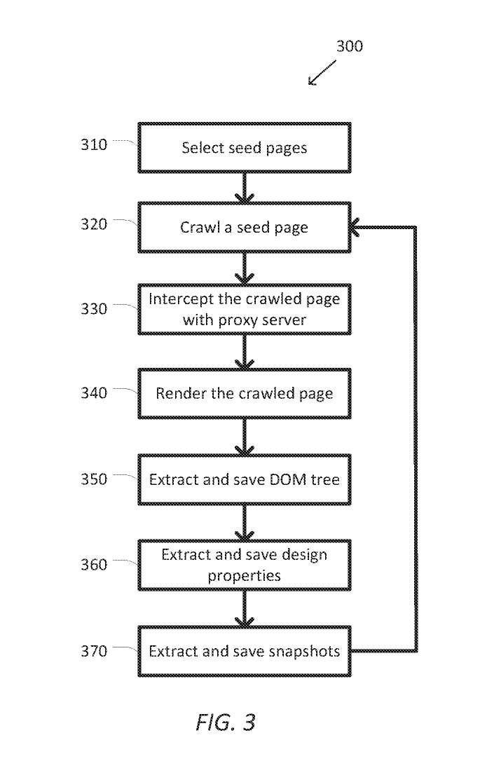

FIG. 3 is a simplified diagram of a method 300 of design property extraction according to some examples. In some examples, one or more of the processes 310-370 of method 300 may be implemented, at least in part, in the form of executable code stored on non-transient, tangible, machine readable media that when run by one or more processors (e.g., the processor 120 of server 110) may cause the one or more processors to perform one or more of the processes 310-370. In some examples, method 300 may be used by a collection system, such as collection system 140, to retrieve and process web pages to determine the design properties of the retrieved web pages.

At a process 310, seed pages are selected. As a general prerequisite for web crawling, a set of one or more seed pages are selected as a starting point. In some examples, each of the seed pages may be represented by a corresponding URL. In some examples, the one or more seed pages may correspond to web pages that correspond to web pages regarded as having a good design. In some examples, the seed pages may be determined based on a trendset and/or a query result generated by query system 150. In some examples, the seed pages may be proposed by a client and/or a user of the collection system. In some examples, the seed pages may be supplied in a flat file, as arguments to an API or web service call, and/or the like. In some examples, the seed pages may be organized into a queue.

At a process 320, one of the seed pages is crawled. A web crawler, such as web crawler 210, may systematically request each of the seed pages, such as by dequeing each in turn from the queue organized during process 310. In some examples, as the web crawler receives each of a requested page, the web crawler may parse the requested page to identify additional links and/or URLs that may be added to the queue of seed pages to create an ever-growing queue of seed pages to be requested. In some examples, the web crawler may omit adding URLs to the queue that have previously been requested. In some examples, the web crawler may request the page through a proxy server, such as proxy server 212.

At a process 330, the crawled page is intercepted by the proxy server. Because the design elements and/or properties of a web page are not always reflected in the raw HTML, the proxy server is used to intercept each resource request used to retrieve the crawled page. This includes resources such as embedded content, images, cascading style sheets (CSSs), and/or the like. In some examples, the crawled page and each of the resources are then tagged with an identifier associated with the crawled page.

At process 340, the crawled page is rendered. After the crawled page and its resources have been retrieved they are passed to a renderer, such as renderer 214 for processing. In some examples, the renderer includes a web browser instance, such as a Webkit browser, that is capable of using the crawled page and the resources to render the crawled page as it would be displayed on a mobile device, tablet, and/or computer screen.

At a process 350, a DOM tree for the crawled page is extracted and saved. A property extractor, such as property extractor 216, parses the HTML for a crawled page as well as the other resources to determine the hierarchy of the crawled page. In some examples, this includes beginning with a root DOM element of the crawled page and recursively determining one or more child DOM elements until both the hierarchy and each of the DOM elements for the crawled page are determined. The property extractor then saves the DOM elements and their relationships in a DOM model, such as DOM model 222 of design repository 160.

In some examples, a bounding box for each DOM element that describes a screen space position of the DOM element is determined and then used to determine whether the DOM element contributes to the visual rendering of its crawled page. In some examples, the bounding box and/or its properties for each DOM element may be recorded as part of the DOM model. In some examples, the bounding box of each DOM element is examined to determine whether it is too small, off screen, and/or completely overlapped by other DOM elements and thus does not contribute in a meaningful way to the design of the crawled page. In some examples, when a DOM element does not contribute meaningfully to the design of the crawled page it may be removed and/or pruned from the DOM tree and is not recorded in the DOM model.

At a process 360, design properties are extracted and saved. The design properties for each of the DOM elements recorded in the DOM model are extracted from the raw HTML and/or the other resources for the crawled page and save in the design repository, such as in properties 224 of design repository 160. In some examples, the design properties may be determined by correlating information found in the raw HTML for the crawled page, the crawled page source, the DOM model, the other resources for the crawled page (such as CSS information), and/or one or more screenshots available through the renderer. In some examples, the design properties extracted and stored may include information associated with colors, fonts, sizes, and/or the like. In some examples, the design properties for a DOM element may be inherited from other DOM elements, assigned via a CSS, explicitly set in the raw HTML source, and/or are present in an embedded image. In some examples, the design properties may additionally be determined based on general design classifications for the crawled page and its content. In some examples, the classifications may include determinations of whether the crawled page is monotone, colorful, bright, dark, light, blue-palette, tri-tone palette, and/or the like based on one or more parametric models and/or heuristic rules for making a classification determination. In some examples, image processing may be used to determine color palette histograms of the crawled page and/or to determine whether background and/or other images include features such as large faces, animations, and/or the like. In some examples, relative frequency of the colors in the color palette histogram may be used to label each of the colors as “coverage,” “accent,” or “detail.”

According to some embodiments, one or more additional design properties for the web page and/or the website to which the web page belongs may also be extracted and saved. In some examples, the one or more additional design properties may be identified by parsing the web page and/or website for the presence of text patterns, use of in-memory data variables when the web page and/or website is loaded and rendered, and/or the like. In some examples, the additional design properties may include one or more of use of one or more design frameworks, use of one or more web technologies and/or libraries, version numbers of the one or more design frameworks, web technologies, and/or libraries, one or more dates associated with the web page or website, legibility, modernity, usage of CSS animations, responsiveness when loaded and rendered for various devices, inclusion of semantic concepts that indicates an association with a particular business, and/or the like. In some examples, contact information for the web page and/or website may also be extracted and saved.

At a process 370, snapshots are extracted and saved. The property extractor uses the renderer to obtain screen shots of rendered images of the crawled page and/or rendered images of DOM elements based on the bounding boxes for the DOM elements. The screen shots may then be saved in the design repository, such as by using snapshots 226 of design repository 160. In some examples, the screen shots may include representative examples of design properties as used on the crawled page. Upon completion of process 370, method 300 continues by returning to process 320 to crawl another page from the seed pages.

Although not shown in FIG. 3, method 300 may also be repeated periodically and/or on demand. In some examples, method 300 may be repeated when additional seed pages are provided. In some examples, method 300 may be repeated to capture trends and/or evolutions in the design of the crawled pages over time.

As discussed above and further emphasized here, FIG. 3 is merely an example which should not unduly limit the scope of the claims. One of ordinary skill in the art would recognize many variations, alternatives, and modifications. In some embodiments, process 330 is performed without the use of the proxy server. In some examples, the crawled page is received and the resource requests are intercepted by the web crawler.

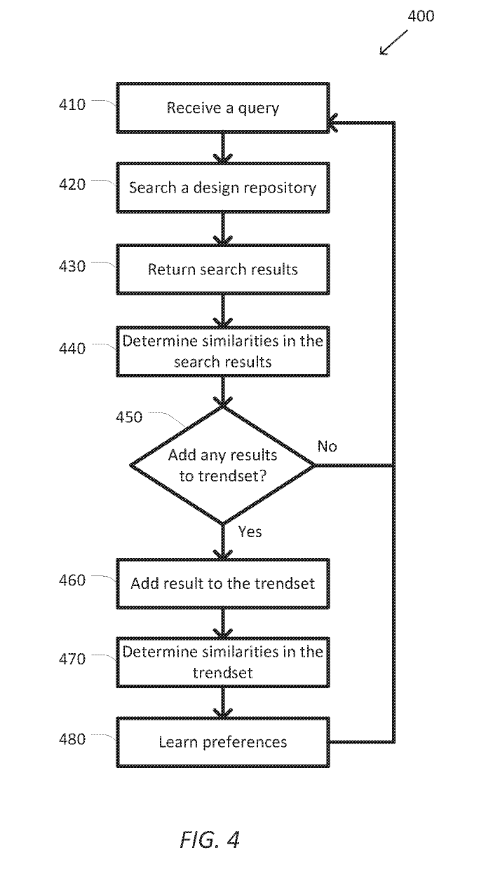

FIG. 4 is a simplified diagram of a method 400 of querying a design repository according to some embodiments. In some examples, one or more of the processes 410-480 of method 400 may be implemented, at least in part, in the form of executable code stored on non-transient, tangible, machine readable media that when run by one or more processors (e.g., the processor 120 of server 110) may cause the one or more processors to perform one or more of the processes 410-480. In some examples, method 400 may be used by a query system, such as query system 150, to search for and identify web pages in a design repository, such as design repository 160 and/or the design repository created during method 300.

At a process 410, a query is received. The query may be received by the query system, such as query system 150, through an API, such as API 230, from a client and/or a user. In some examples, the query may be received in the form a parameterized API call, web service request, and/or the like.

At a process 420, a design repository is searched. The query received during process 410 is used as a basis for performing a query on a design repository, such as design repository 160. The query is examined by a query engine, such as query engine 232, to determine which design properties and respective design property values are to be used as a basis for the search. In some examples, the design property values may be explicitly specified in the query (such as a font of Helvetica) and/or by a range either expressly and/or indirectly specified (such as a font size larger than 24 points and a color of red, respectively). In some examples, the query may include one or more similarity clauses that indicate a comparison for similarity and/or dissimilarity to one or more design properties of a previous identified one or more web pages from a result set, such as result set 236, and/or a one or more trendsets, such as any of the trendsets 240. In some examples, the API and the queries it may accept are sufficiently robust to answer any of the design query questions described in the context of FIG. 2. Once the design properties and respective design property values are determined, the query engine uses them to search the design repository for web pages matching the search criteria. In some examples, when the design repository is implemented as a database, the query may be converted to one or more SQL select statements, which are then submitted to the design repository by the query engine.

At a process 430, search results are returned. The results, if any, to the search performed during process 420 are returned. In some examples, the results may include a result set of web pages and/or DOM elements that satisfy the search criteria of the query received during process 410. In some examples, the search results may include a screen shot of each of the web pages in the result set so that the web pages and the design properties they embody may be displayed to a user. In some examples, the search results may further include a color palette for each of the web pages in the result set so that the most common colors used by the web page may be displayed to the user. In some examples, the search results may include screen shots of one or more design properties as actually used on a web page. In some examples, the screen shots may be retrieved from a collection of screen shots stored in the design repository, such as the screen shots stored in snapshots 226 of design repository 160. In some examples, the search results may include information indicative of the popularity of the returned web pages, such as by reporting how many times the web page has been returned by searches, how many “likes” the web page has received, how popular the web page is relative to other web pages in the design repository, and/or the like. In some examples, when the size of the result set is larger than a configurable threshold, such as 20, the results may be returned in groups of the size of the threshold. In some examples, the results may be ordered based on how closely the results match the design properties in the query received during process 410. In some examples, the ordering may be based on closeness of color, closeness of font size, strength of classification of the web page or the design property, and/or the like and/or any combination of factors.

At a process 440, similarities in the search results are determined. Each of the web pages in the search results and/or a selected subset of the web pages in the search results of process 430 is examined to determine the design properties that each of the web pages have in common using a similarity engine, such as similarity engine 234. In some examples, similarities in design properties may be determined based on exact matches between design properties (e.g., all examples use the Roboto font, all examples include a specific shade of red, etc.). In some examples, similarities in properties may be determined based on approximate matches in design properties (e.g., all examples use a shade of red, all examples use a san serif font, etc.) In some examples, the similarity engine may additionally determine one or more lists and/or ordered lists of design properties in each of the examples. In some examples, the similar design properties and/or design properties lists may then be used to support additional query functionality during process 420.

At a process 450, it is determined whether any of the results are to be added to a trendset. As a result of receiving the results of the query during process 430, the user may determine that one or more of the results from the result set are to be included in a collection of web pages of interest or a trendset, such as any of the trendsets 240. In some examples, selections from the result set to be added to the trendset may be communicated to the query system using one or more API calls. When no results are to be added to the result set, the query system returns to process 410 to wait for another query. When one or more of the results in the result set are to be added to the result set, the request is processed beginning with a process 460.

At the process 460, the result is added to the trendset. The results selected during process 450 for inclusion in a trendset are added to the trendset. In some examples, each of the selected results may be added to the trendset using an insert and/or similar function.

At a process 470, similarities in the trendset are determined. Each of the web pages in the trendset is examined to determine the design properties that each of the web pages have in common using a similarity engine, such as similarity engine 234. In some examples, similarities in design properties may be determined based on exact matches between design properties (e.g., all examples use the Roboto font, all examples include a specific shade of red, etc.). In some examples, similarities in properties may be determined based on approximate matches in design properties (e.g., all examples use a shade of red, all examples use a san serif font, etc.) In some examples, the similarity engine may additionally determine one or more lists and/or ordered lists of design properties in each of the examples. In some examples, the similar design properties and/or design properties lists may then be used to support additional query functionality during process 420.

At a process 480, preferences are learned. As web pages are added to the trendset as a result of the selection during process 450, the query system may learn preferences and/or associations among the web pages in the trendset and the web pages added to the trendset during process 460 using a preference learner, such as preference learner 238. In some examples, the preference learner may use correlations between design properties of the web pages in the trendset, queries received during process 410, and/or changes made to the trendset to determine the preferences and/or associations. After completion of process 480, the query system returns to process 410 to wait for another query.

As discussed above and further emphasized here, FIG. 4 is merely an example which should not unduly limit the scope of the claims. One of ordinary skill in the art would recognize many variations, alternatives, and modifications. In some embodiments, different events than the selection of a result to add to the trendset may result in the performance of processes 460-480. In some examples, the different events may include removing one or more web pages form the trendset, replacing the trendset with the results of a query, and/or the like.

Some examples of server 110 may include non-transient, tangible, machine readable media that include executable code that when run by one or more processors (e.g., processor 120) may cause the one or more processors to perform the processes of methods 300 and/or 400 as described above. Some common forms of machine readable media that may include the processes of methods 300 and/or 400 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method of identifying design examples using a query system hosted on a server having one or more processors and memory, the method comprising:
receiving a first query;
searching a design repository to determine a result set having one or more first design examples based on the first query, the design repository storing document object model (DOM) trees, DOM elements, first design properties, and snapshots;
returning the first design examples;
determining one or more first similarities among second design properties of second design examples selected from the first design examples; and
using the first similarities as a basis for one or more second queries.

2. The method of claim 1, wherein determining the first similarities comprises creating one or more lists of the second design properties of the second design examples.

3. The method of claim 2, further comprising ordering at least one of the lists based on how often a corresponding design property is used in the second design examples.

4. The method of claim 1, further comprising:
determining whether one or more of the first design examples are to be added to a trendset; and
when the one or more of the first design examples are to be added to the trendset, adding the one or more of the first design examples to the trendset and determining one or more second similarities of third design properties in third design examples in the trendset.

5. The method of claim 4, further comprising when the one or more of the first design examples are to be added to the trendset, determining preferences associated with the third design examples in the trendset.

6. The method of claim 4, further comprising using the second similarities as a basis for the second queries.

7. The method of claim 1, wherein returning the first design examples comprises returning a screen shot of each of the first design examples, the screen shot being retrieved from the snapshots.

8. The method of claim 1, wherein returning the first design examples comprises returning a color palette of each of the results.

9. The method of claim 1, wherein returning the first design examples comprises returning a screen shot of a representative example of a third design property that corresponds to each of the first design examples.

10. The method of claim 1, wherein returning the first design examples comprises returning an indicator of a popularity of each of the first design examples.

11. A method of extracting design properties associated with a web page using a collection system hosted on a server having one or more processors and memory, the method comprising:
retrieving the web page using a web crawler;
retrieving one or more resources associated with the web page using the web crawler;
rendering the web page using a web browser instance;
extracting a domain object model (DOM) tree for the web page, the DOM tree comprising one or more DOM elements;
saving the DOM elements and the DOM tree in a design repository;
extracting one or more design properties for each of the DOM elements from the web page and the resources;
saving the design properties in the design repository;
extracting a first screen shot for at least one of the DOM elements from the rendered web page; and
saving the first screen shot in the design repository.

12. The method of claim 11, further comprising using a proxy server to retrieve the web page and the one or more resources associated with the web page.

13. The method of claim 11, further comprising:
extracting a second screen shot for the web page; and
saving the second screen shot in the design repository.

14. The method of claim 13, further comprising:
determining a plurality of color buckets by quantizing colors in the second screen shot;
generating a histogram based on the color buckets and the colors in the second screen shot; and
generating a color palette for the web page based on the histogram.

15. The method of claim 11, further comprising determining a list of fonts appearing in the rendered web page.

16. A system comprising:
a first server comprising a first memory and one or more first processors coupled to the first memory, the first server being configured to implement a query system;
wherein the query system is configured to:
receive a first query;
search a design repository to determine a result set having one or more first design examples based on the first query, the design repository storing first document object model (DOM) trees, first DOM elements, first design properties, and first snapshots;
return the first design examples;
determine one or more first similarities among second design properties in second design examples selected from the first design examples; and
use the first similarities as a basis for one or more second queries.

17. The system of claim 16, wherein the query system is further configured to:
determine whether one or more of the first design examples are to be added to a trendset; and
when the one or more of the first design examples are to be added to the trendset, add the one or more of the first design examples to the trendset and determine one or more second similarities of third design properties in third design examples in the trendset.

18. The system of claim 17, wherein when the one or more of the first design examples are to be added to the trendset, the query system is further configured to determine preferences associated with the third design examples in the trendset.

19. The system of claim 16, further comprising:
a second server comprising a second memory and one or more second processors coupled to the second memory, the second server being configured to implement a collection system;
wherein the collection system is configured to:
retrieve a web page using a web crawler;
retrieve one or more resources associated with the web page using the web crawler;
render the web page using a web browser instance;
extract a second DOM tree for the web page, the second DOM tree comprising one or more second DOM elements;
save the second DOM elements and the second DOM tree in the design repository;
extract one or more third design properties for each of the second DOM elements from the web page and the resources;
save the third design properties in the design repository;
extract a first screen shot for at least one of the second DOM elements from the rendered web page; and
save the first screen shot in the design repository.

20. The system of claim 19, wherein the first server and the second server are a same server.
